(19) United States
(12) Patent Application Publication
(10) Pub. No.: US 2011/0238259 A1
(43) Pub. Date: Sep. 29, 2011

(54) V2X-Connected Cooperative Diagnostic & Prognostic Applications in Vehicular AD HOC Networks

(75) Inventors: Fan Bai, Ann Arbor, MI (US); Yilu Zhang, Northville, MI (US)

(73) Assignee: GM GLOBAL TECHNOLOGY OPERATIONS, INC., Detroit, MI (US)

(21) Appl. No.: 12/731,395

(22) Filed: Mar. 25, 2010

(51) Int. Cl. G06F 19/00

(52) U.S. Cl. 701/33

(57) ABSTRACT

A method is provided for processing and analyzing diagnostic and prognostic data in a vehicle ad-hoc network. Diagnostic and prognostic data is exchanged between a host vehicle and remote vehicles in the vehicle ad-hoc network. The received diagnostic and prognostic data is stored in a memory of the host vehicle. Redundancy is eliminated in the received diagnostic and prognostic data. The diagnostic and prognostic data is assigned to clusters. Anomalies are detected in the stored data utilizing clustering techniques that determine whether a cluster of diagnostic and prognostic data formed from the host vehicle substantially deviates from the clusters of diagnostic and prognostic data formed from the remote vehicles. A driver of a vehicle is notified if the cluster data from a host vehicle deviates significantly from the clusters from the remote vehicles.

### BACKGROUND OF INVENTION

An embodiment relates generally to a vehicle-to-vehicle communication ad hoc network.

In vehicle-to-vehicle (V2V) communications, vehicles typically communicate with centralized back-end server via a base station to supply vehicle information for analysis. The backend server is capable of storing and processing data for a large number of vehicles within a city or other geographical location. Typically such communications would be performed using cellular service. Such a system could be used to input diagnostic and prognostic data for analysis; however, such a centralized system would demand a great amount of processing power and would be costly to process. In addition, the communication link utilizing cellular communications between the vehicles and backend servers would be costly and would have limited bandwidth. As a result, both the cellular system and the backend server could be overloaded and the overall system will have a scalability issue should an attempt to transmit diagnostic and prognostic data for analysis for such a larger group of vehicles.

### SUMMARY OF INVENTION

An advantage of an embodiment is a determination of an anomaly or predicted failure utilizing an in-vehicle diagnostic and prognostic analysis method that uses compiled data from remote vehicles and compares diagnostic and prognostic data of the remote vehicle with the diagnostic and prognostic data of the host vehicle. The embodiment of the invention also reduces redundancy in the received data for reducing the computational processing time and reduces any biases that could skew the results.

An embodiment contemplates a method of processing and analyzing diagnostic and prognostic data in a vehicle ad-hoc network. Diagnostic and prognostic data is exchanged between a host vehicle and remote vehicles in the vehicle ad-hoc network. The received diagnostic and prognostic data is stored in a memory of the host vehicle. Redundancy is eliminated in the received diagnostic and prognostic data. Anomalies are detected in the stored data utilizing a clustering technique that determines whether a cluster of diagnostic and prognostic data formed from the host vehicle substantially deviates from the clusters of diagnostic and prognostic data formed from the remote vehicles. A driver of a vehicle is notified if the cluster data from a host vehicle deviates significantly from the clusters from the remote vehicles.

### BRIEF DESCRIPTION OF DRAWINGS

FIG. 1 is an example of a traffic flow diagram.

FIG. 2 is a block diagram of the system architecture for a vehicle-to-vehicle communication system.

FIG. 3 is a transition flow diagram for obtaining diagnostic and prognostic messages from remote vehicles.

FIG. 4 illustrates a data block of information included in messages broadcast by vehicles in the vehicle-to-vehicle communication system.

FIG. 5 is a schematic representation of a hash function for reducing the redundancy.

FIG. 6 is a diagram of a clustering technique for detecting anomalies.

FIG. 7 is a graphic illustration of a cluster model graph for predicting failures.

FIG. 8 is a flowchart of a method for detecting anomalies using diagnostic and prognostic data from remote vehicles.

### DETAILED DESCRIPTION

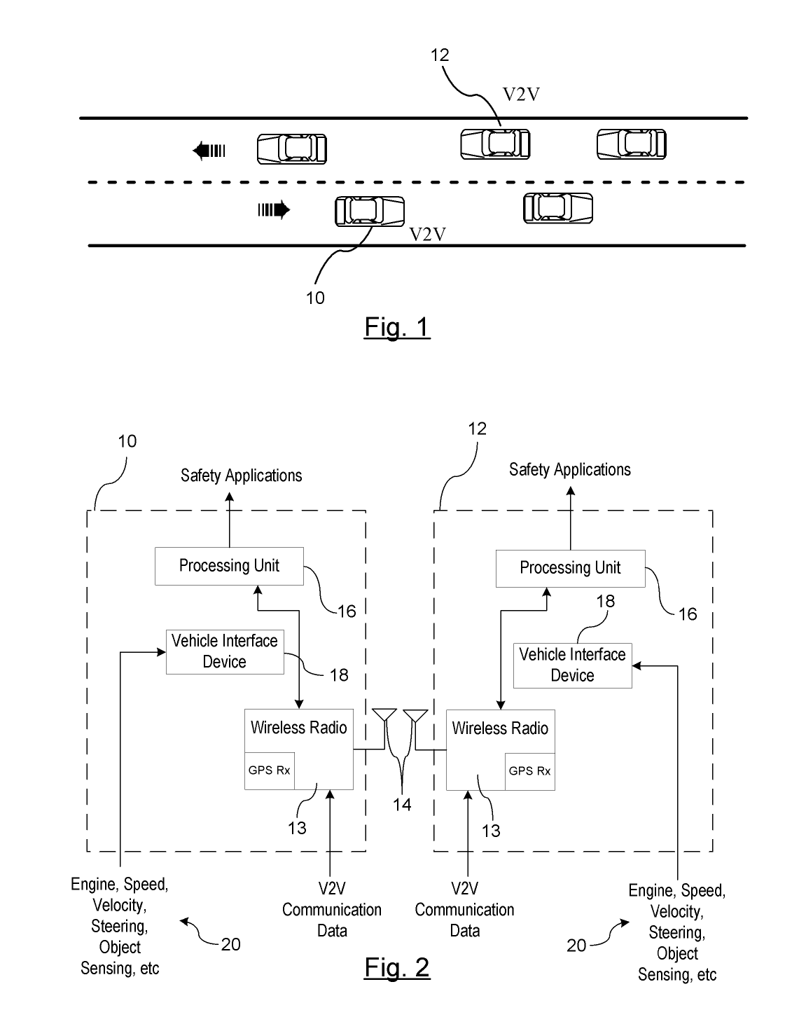

There is shown generally in FIG. 1 a traffic flow diagram illustrating a host vehicle 10 and a remote vehicle 12. The remote vehicle 12 has communication capabilities with the host vehicle 10 known as vehicle-to-vehicle (V2V) messaging. The host vehicle 10 and the remote vehicle 12 send wireless messages to one another over a respective inter-vehicle communication network (e.g., DSRC).

Vehicle-to-vehicle (V2V) wireless messages communicated between the vehicles may be transmitted as a standard message. The wireless message includes data regarding a vehicle's operating conditions, environmental awareness conditions, vehicle kinematics/dynamic parameters. The advantage of an embodiment described herein is that the vehicle may communicate diagnostic and prognostic (P&D) data about its own vehicle for comparison purposes. This allows each vehicle to independently process the collected data from the remote vehicle and compare it to its own data to determine whether any of its own operating parameters are not within a norm of other surrounding vehicles.

FIG. 2 illustrates the vehicle-to-vehicle communication system between a host vehicle 10 and at least one remote vehicle 12. The host vehicle 10 and the remote vehicle 12 are each equipped with a wireless radio 13 that includes a transmitter and a receiver (or transceiver), such as a dedicated short range communication (DSRC) device for broadcasting and receiving the wireless messages via an antenna 14. The host vehicle 10 and remote vehicle 12 further include respective processing units 16 for processing the data received in the wireless message or other transmitting devices such as a global positioning system (GPS) receiver. Each vehicle also includes a vehicle interface device 18 for collecting data received from an array of sensors 20 that includes, but not limited to, speed, braking, yaw rate, acceleration, and steering, engine operating parameters such as speed, temperature, battery voltage, and object detection sensors.

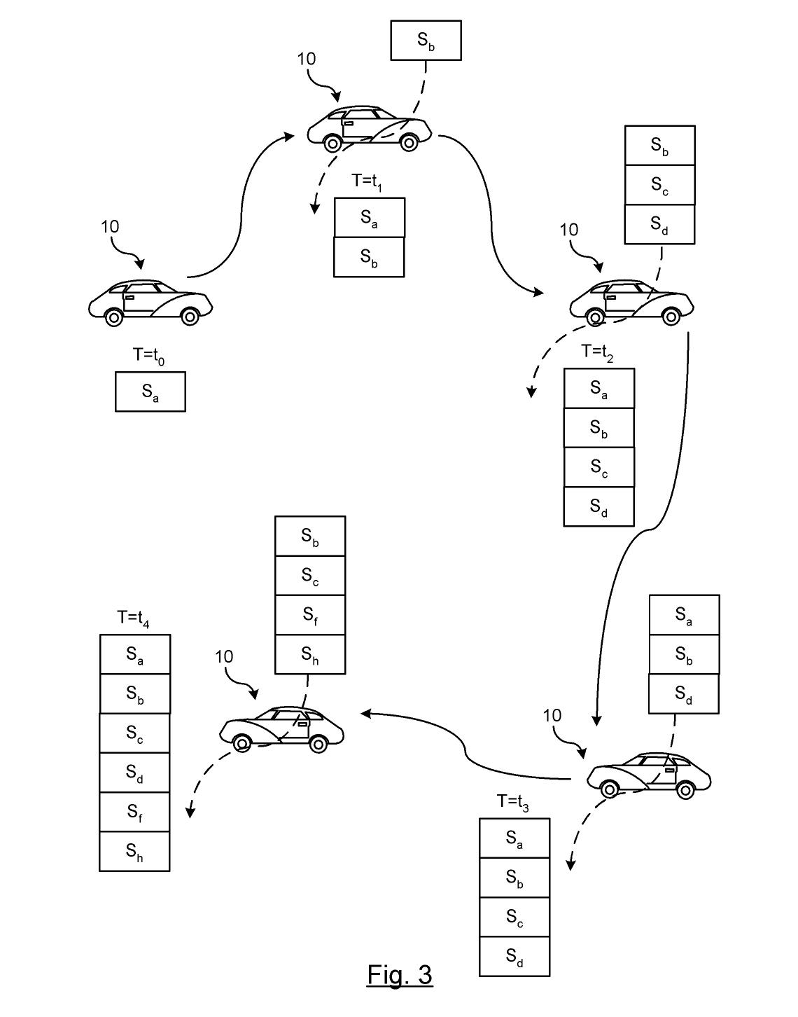

FIG. 3 illustrates a host vehicle 10 collecting and broadcasting vehicle diagnostic and prognostic (D&P) data with respect to a plurality of remote vehicles. It should be understood that the host vehicle 10 can collect D&P data not only in a message directly communicated to the host vehicle 10, but D&P data stored by the remote vehicle which is overheard from other remote vehicles in the past.

There is shown at T=t₀, the host vehicle 10 in communication with remote vehicle Sₐ. The host vehicle receives D&P data broadcast by Sₐ and stores the D&P data in a memory (e.g., database). A time T=t₁, the host vehicle 10 communicates with vehicle S_{b} and stores D&P data in the memory. At time T=t₂, the host vehicle 10 communicates with vehicle S_{d} which has encountered other remote vehicles S_{b}, S_{c} before it encounters the host vehicle. It should be understood that the D&P data obtained from each of the remote vehicles can be the D&P data of the remote vehicle itself or the D&P data that the remote vehicle collected from other remote vehicles. For example, remote vehicle S_{d} can communicate D&P data relating to S_{c} and S_{b} based on D&P data stored in its memory from previous communications with vehicles S_{c} and S_{b}. Alternatively, the host vehicle 10 may overhear communications between two respective remote vehicles (e.g., S_{c} and S_{b}) and store the respective D&P data that was overheard in the host vehicle's memory. The additional time instances shown in FIG. 2 illustrate the collection of D&P data from other remote vehicles by either direct communication, by a remote vehicle transmitting D&P data of other remote vehicles stored in its memory, or by D&P data overheard between two other remote vehicles. As a result, the host vehicle 10 can obtain an abundance of D&P data from a plurality of remote vehicles without having direct communication with each of the plurality of remote vehicles.

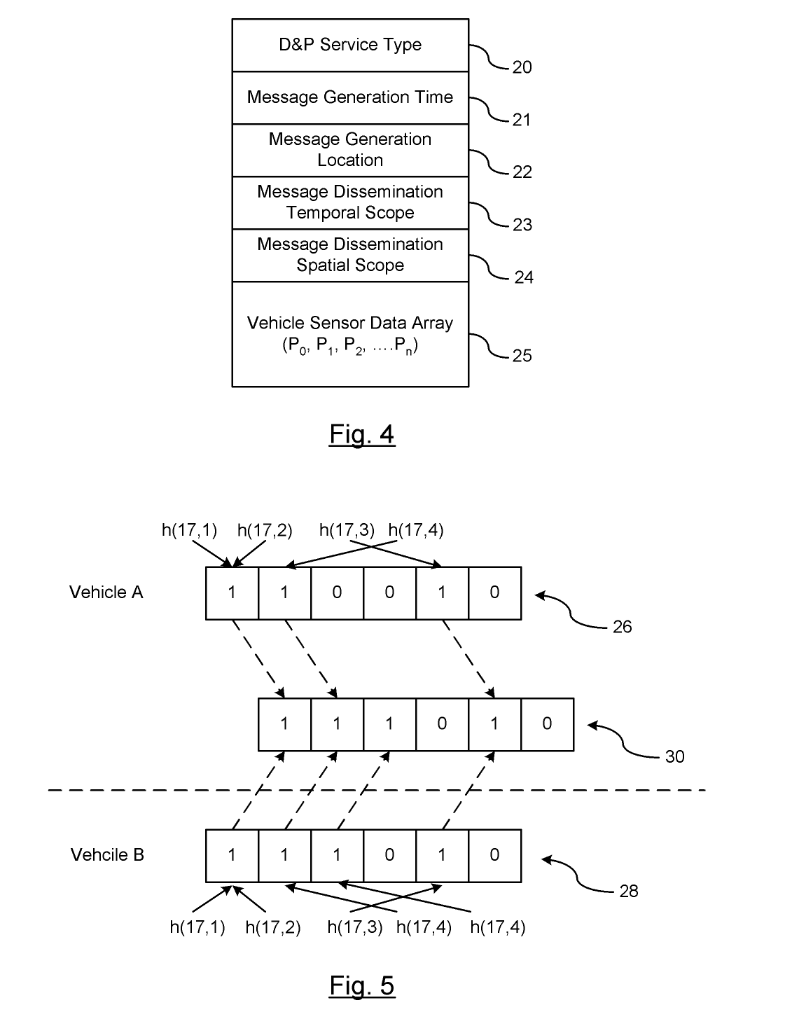

FIG. 4 illustrates a data block of D&P information composed within a vehicle message. Each data block includes, but is not limited to, the type of D&P service performed by the vehicle 20; a message generation time 21; a message generation location 22; a message dissemination temporal scope 23 (e.g., how long the message should be maintained); a message dissemination spatial scope 24 (which geographical locations the message should maintained for); and vehicle sensor data 25.

Due to the abundance of the D&P data obtained from the plurality of vehicles, a large portion of the D&P data overlaps (e.g., duplicative) resulting in redundancy of D&P data. Therefore, there exists a need to eliminate redundancy in the D&P data. FIG. 5 illustrates a schematic representation of a hash function used to reduce the redundancy. The hash function is a probabilistic counting hash function that may include any one of a variety of hash functions such as, but not limited to, Flagolet-Martin Sketch logic. When two D&P vectors from two vehicles are merged, the hash function could be used to determine if, there is any redundancy between these two vectors in an efficient fashion (without examining data items of each data vector). Should such redundancy exists, redundancy can be eliminated. As shown in FIG. 5, D&P vectors for vehicle A are represented generally by 26. D&P vectors for vehicle B are represented generally by 28. Utilizing Flagolet-Martin Sketch logic, redundancy is eliminated by merging the two D&P vectors from vehicles A and B into a resultant D&P vector represented generally by 30.

Once redundancy is eliminated in the D&P stored data, anomaly detection is applied to the D&P data and the driver is notified of any such anomalies or predicted faults/failures within the vehicle as determined by a comparison between the host vehicle D&P data and the D&P data from the plurality of vehicles. Anomaly detection is achieved using clustering techniques. The following is an example of a respective clustering technique, but it should be understood that the clustering technique as described herein is only one embodiment, and that other clustering techniques may be utilized without deviating from the scope of the invention. The exemplary clustering technique involves grouping the D&P data of each remote vehicle into clusters according to respective criteria. First, cluster centers are initialized for a given set of data. Initializing the cluster centers may be represented by the following equations:

cₘ⁽⁰⁾ m=1 . . . M

where cₘ represents a respective cluster center, and

X={xₙ, n=1 . . . N}

where xₙ represents data point, and n represents the count.

The data is then assigned to clusters. Assigning data to the clusters is represented by the following equation:

$${ω}_{mn}^{( t )} = \{ \begin{matrix}1 & if m = arg min D ( {x}_{n} , {c}_{j}^{( i )} ) j = 1 : M \\ 0 & otherwise\end{matrix} \}$$

where ωₘₙ represents the membership function for determining whether the data point belongs to a cluster, D represents a distance, xₙ represents a data point, cⱼ⁽ⁱ⁾ represents the cluster centers, and j represents the count of the clusters. A respective D&P data is assigned to a cluster based on its distance to a cluster center. That is, the cluster center that is the least amount of distance from the respective D&P data point is assigned to that associated cluster.

After data is assigned to the clusters, cluster centers are re-estimated. Re-estimating the cluster centers facilitates a determination of whether the cluster centers are converging. Re-estimating the cluster centers is performed using the following equation:

$${c}_{m}^{( t + 1 )} = \frac{{\sum }_{n = 1}^{N} {ω}_{mn}^{( t )} {x}_{n}}{{\sum }_{n = 1}^{N} {ω}_{mn}^{( t )}} .$$

Upon completion of re-estimating the cluster centers, a determination is made whether the re-estimated cluster centers converge with one another. If the cluster centers do not converge, then a determination is made that the data is too widespread with respect to the remote vehicles such that a comparison with the cluster of the host vehicle is not feasible. A return is made to obtain more data and assign the data to the respective clusters.

If the determination is made that the cluster centers converge, then a determination is made whether the cluster of host vehicle D&P data significantly deviates from the converged clusters of remote vehicles D&P data. A substantial deviation may be evident by the of D&P data of the host vehicle cluster deviating from the cluster of D&P data of the remote vehicle by a predetermined range or by a factor of a standard deviation of the converged clusters.

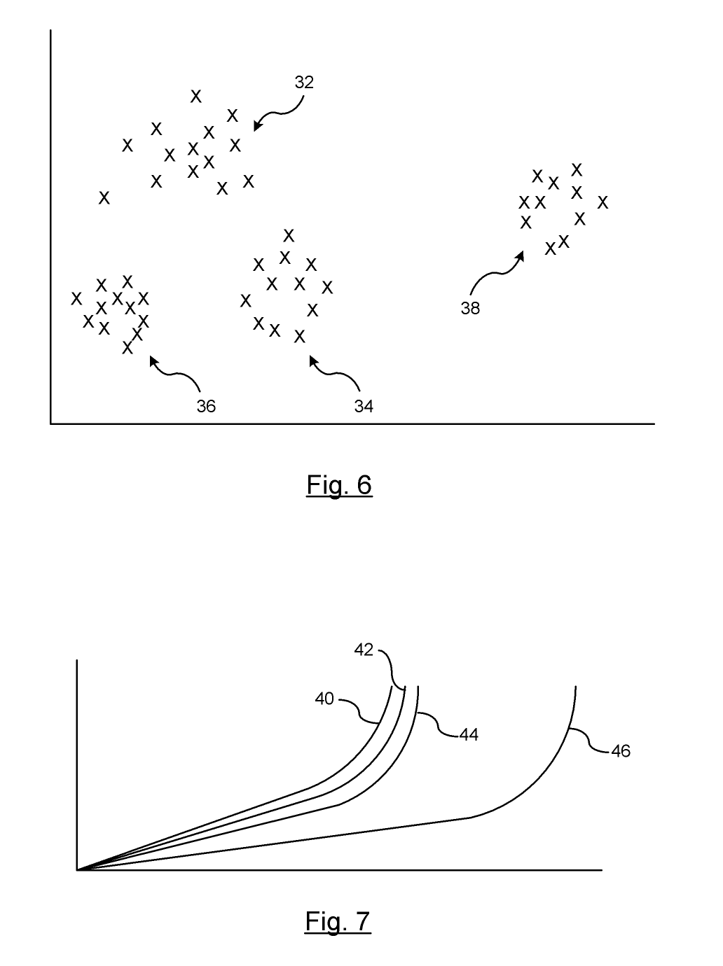

FIG. 6 illustrates a diagrammatic illustration of a clustering technique. Clusters of D&P data of remote vehicles is shown generally at 32, 34, and 36. Each of the clusters represents a same criteria; however, the various clusters may represent the criteria under respective operating conditions. For example, the D&P data may be engine temperature data for the remote vehicles, but each cluster may represent the engine temperature when the vehicle is at idle, or on the highway, or city driving. A cluster of D&P data of the host vehicle is shown generally at 38. A comparison is made to determine if the cluster of the host vehicle substantially deviates from the clusters of the remote vehicles 32, 34, and 36. As shown in FIG. 6, the cluster of D&P data of the host vehicle 38 deviates substantially from the D&P data of the remote vehicles 32, 34, and 36.

FIG. 7 illustrates yet another example of the modeling technique for determining an anomaly. Degradation curves for the remote vehicles, which are constructed from the D&P data, are illustrated generally at 40, 42, and 44. The host vehicle degradation curve is illustrated generally at 46. As shown in FIG. 7, the degradation curve of the host vehicle 46 deviates substantially from the degradation curves of the remote vehicles 40, 42, and 44. As a result, failure prediction can be readily determined from the comparison of cluster data between the remote vehicles and the host vehicle.

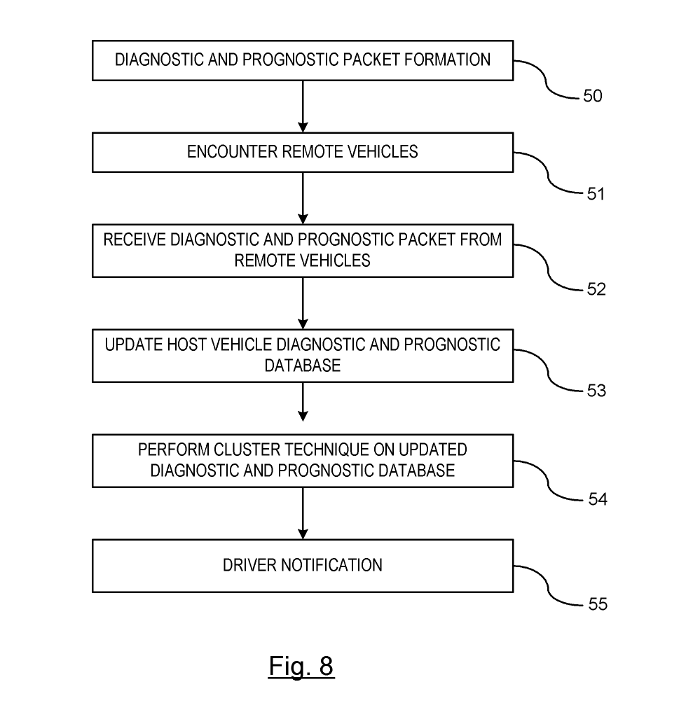

FIG. 8 illustrates a flowchart of a method for detecting anomalies within a host vehicle. In step 50, D&P data for each vehicle is composed within a message.

In step 51, communication by a remote vehicle is detected.

In step 52, D&P data is received by the remote vehicle. The D&P data obtained by the host vehicle may include D&P data obtained by direct communication, by a remote vehicle transmitting D&P data of other remote vehicles which has been received in the past and stored in its memory, or by D&P data overheard between two other remote vehicles. If direct communication with a remote vehicle is established, then the host vehicle will transmit its D&P data to the remote vehicle.

In step 53, D&P data is updated within the host vehicle memory/database. D&P data from the remote vehicles are checked for redundancy. A hash based probabilistic counting function (e.g., Flajolet-Martin Sketch Logic) is used to merge two D&P vectors of two remote vehicles to avoid overcounting the same data which could otherwise bias the analysis.

In step 54, a clustering technique is performed on the updated D&P data for determining whether an anomaly exists and predict impending failures. It should be understood that one or more clustering techniques may be used by a processing unit for determining whether the anomaly exists. The data is assigned to clusters based on respective criteria. Clusters are determined for the remote vehicles and for the host vehicle. Center points for each cluster are estimated. As each of the cluster center points for the remote vehicles are evaluated, a determination is made whether the cluster center points converge. If the cluster center points for the remote vehicles converge, then a comparison is performed between the cluster for the host vehicle the cluster of the remote vehicles. A determination of whether the cluster of the host vehicle substantially deviates from the clusters of the remote vehicles may be determined by whether the deviation is more than a predetermined threshold such as a predetermined range or by a standard deviation or a factor of a standard deviation.

In step 56, the driver is notified of the anomaly or impending failure in response to a determination that the cluster of the host vehicle substantially deviates from the cluster of the remote vehicle. Driver notification may be provided by visual, audible, or haptic device such as a human machine interface device. Alternatively, the warning may be provided by a wireless communication network based service which provide services such as, but not limited to, in-vehicle security, remote diagnostics systems, and other services via a wireless communication link with a fixed entity.

It should be understood that the on-board collection, analysis and processing of the D&P data not only detects anomalies and failures, but reduces redundancy in the received data which reduces the computational processing time of the data and reduces biases that could otherwise skew the data.

While certain embodiments of the present invention have been described in detail, those familiar with the art to which this invention relates will recognize various alternative designs and embodiments for practicing the invention as defined by the following claims.

What is claimed is:

1. A method of processing and analyzing diagnostic and prognostic data in a vehicle ad-hoc network, the method comprising the steps of:
exchanging diagnostic and prognostic data between a host vehicle and remote vehicles in the vehicle ad-hoc network;
storing the received diagnostic and prognostic data in a memory of the host vehicle;
eliminating redundancy in the received diagnostic and prognostic data;
detecting anomalies in the stored data utilizing a clustering technique that determines whether a cluster of diagnostic and prognostic data formed from the host vehicle substantially deviates from the clusters of diagnostic and prognostic data formed from the remote vehicles; and
notifying a driver of a vehicle if the cluster data from a host vehicle deviates significantly from the clusters from the remote vehicles.

2. The method of claim 1 wherein a hash function based probabilistic counting technique is used to reduce redundancies.

3. The method of claim 4 wherein the hash function based probabilistic counting technique includes Flajolet-Martin sketch logic.

4. The method of claim 1 wherein a dedicated short range communication protocol is used as a communication channel between the host vehicle and remote vehicles.

5. The method of claim 1 wherein WiFi is used to communicate between the host vehicle and remote vehicles.

6. The method of claim 1 wherein the diagnostic and prognostic data includes operation and fault data from remote vehicles.

7. The method of claim 1 wherein the step of detecting anomalies further comprises:
estimating a center of each respective cluster as diagnostic and prognostic data is assigned to each respective cluster;
determining whether the centers of each respective cluster of the remote vehicles converge with one another; and
determining whether the diagnostic and prognostic data in the cluster of the host vehicle substantially deviates from diagnostic and prognostic data in the clusters of the remote vehicle in response to centers of each respective cluster of the remote vehicles converging.

8. The method of claim 7 wherein determining whether the cluster of the host substantially deviates from the cluster of the remote vehicle includes determining whether the clusters between the host vehicle and the remote vehicles deviate by a predetermined threshold.

9. The method of claim 8 the predetermined threshold is a calculated standard deviation.

10. The method of claim 8 the predetermined threshold is a factor of the calculated standard deviation.

11. The method of claim 1 wherein assigning the diagnostic and prognostic data to clusters further comprises the steps of:
calculating a distance from a respective data point to each cluster center;
determining the respective cluster center that is the minimum distance from the respective data point; and
assigning the respective data point to the cluster having the cluster center that is the minimum distance from the respective data point.

12. The method of claim 1 wherein the anomaly includes a current failure in an operating parameter of the vehicle.

13. The method of claim 1 wherein the anomaly includes a predicted failure in an operating parameter of the vehicle.

14. The method of claim 1 wherein the anomaly is provided to a centralized diagnostic and prognostic reporting system.

15. The method of claim 1 wherein the centralized diagnostic and prognostic reporting system performs error checking.

16. The method of claim 1 wherein the centralized diagnostic and prognostic reporting system performs notifies the driver of the vehicle.

17. The method of claim 1 wherein a human machine interface within the vehicle notifies the driver of the anomaly.
